(19) United States
(12) Patent Application Publication
(10) Pub. No.: US 2007/0043809 A1
(43) Pub. Date: Feb. 22, 2007

(54) Storage network interconnection systems, kits and methods for using the same

(76) Inventors: Joseph L. Aultman SR., Indian Springs, AL (US); Susan Tafolla, Pelham, AL (US)

Correspondence Address: MYERS BIGEL SIBLEY & SAJOVEC, P.A., P.O. BOX 37428, RALEIGH, NC, 27627, US

(21) Appl. No.: 11/188,319

(22) Filed: Jul. 25, 2005

(51) Int. Cl. G06F 15/16

(52) U.S. Cl. 709/203

(57) ABSTRACT

Storage network interconnection systems have a server connection section including a plurality of connector members coupled to respective optical fibers extending to a server distribution point, the server distribution point being configured to couple ones of the optical fibers to storage device interface ports of selected computers. A storage device connection section includes a plurality of connector members coupled to respective optical fibers extending to a storage device distribution point, the storage device distribution point being configured to couple ones of the optical fibers to storage device interface ports of selected storage devices. A switching section includes a plurality of connector members coupled to respective optical fibers extending to a predetermined location where a fiber channel switch having interface ports is to be located, the fiber channel switch being configured to provide selectable cross-connection of a plurality of the interface ports of the fiber channel switch to provide interconnection between the selected computers and the selected storage devices. A plurality of connector members couple ones of the selected computers and the selected storage devices to selected ones of the plurality of connector members of the switching section to couple the ones of the selected computers and the selected storage devices through the fiber channel switch in a desired configuration.

### FIELD OF THE INVENTION

This invention relates to storage devices, and more particularly to connection to such devices.

### BACKGROUND OF THE INVENTION

Various computer processing devices generally require access to some form of mass storage for saving files, data and the like associated with the operations and services supported by the computer processing devices. In addition, a variety of standards have been adopted related to coupling of physical storage devices to computing devices. For example, a variety of personal computers utilize the small computer system interface (SCSI) to attach peripheral storage devices to the personal computers. SCSI is a parallel interface standard that may be used for attaching disk drives, printers and the like to the computer through a SCSI standard port. The SCSI standard is maintained by the American National Standards Institute (ANSI).

As computing devices and network environments become more complex and support a greater variety of applications and users, the demand for access to storage has increased. Furthermore, the speed of access to such storage and the ability to handle transfer of large amounts of data may be important in various applications, particularly where network connected mass storage devices are shared across a plurality of computing devices coupled to the shared network storage devices. Such shared devices may also beneficially incorporate more capable storage devices, such as a redundant array of independent disk (RAID) drive. Such shared mass storage devices may provide for redundancy and protection against data loss. Sub-allocation of limited portions of very high capacity drives across a variety of computing device users may also allow the users to share costs associated with the storage.

A more recent technology for providing a physical layer connection between computing devices and mass storage is fiber channel (FC) technology. Fiber channel is particularly suited for connecting computer servers in a network environment to shared storage devices and for interconnecting storage controllers and drives. A variety of fiber channel standards are provided associated with the fiber channel technology, including those propagated by ANSI, such the ANSI Standard X3.20-1994. Fiber channel technology is gradually replacing interface standards such as SCSI in various application environments. While fiber channel technology standards may provide performance benefits when utilizing optical fiber as a transmission medium, fiber channel standards also support use of coaxial cable, ordinary telephone twisted pair wiring and the like.

Fiber channel may interoperate with SCSI and other computer host bus standards and may further interoperate with Internet Protocol (IP) Networks.

In a typical robust storage infrastructure, shared mass storage devices are located in a location remote from the server devices they support. For example, the disk storage area may be on a different floor of a building from servers that utilize the storage devices. In addition, as it is generally desirable to couple a mass storage device to a plurality of servers, a typical fiber channel infrastructure includes the use of a fiber channel switch between the servers and the storage devices. Such a fiber channel switch is configured to allow selective interconnection between ones of the servers and ones of the storage devices in a programmable manner. In addition, an interface is generally required between the server and storage devices and the fiber channel cables to control packetizing and serial transmission of data over the fiber channel. Such an interface for a server device is generally referred to as a host-bus adaptor. A server generally includes a plurality of host bus adaptors coupled to cables. Use of a plurality of host bus adaptors provides for greater flexibility in routing of data to and from the server and further provides redundancy and back up protection so that access to the fiber channel may be maintained even if an individual host bus adaptor is damaged or defective as such a defective host bus adaptor can be bypassed and an alternative host bus adaptor can be utilized for routing of data to and from the fiber channel.

The adaptor for a storage device coupled to a fiber channel is generally referred to as front edge fiber adaptor. As with host bus adaptors for servers, a mass storage device typically includes a plurality of front edge fiber adaptors. The front edge fiber adaptors are in turn typically coupled to the intelligence of the mass storage device, such as a RAID controller, that is responsible for controlling access to the storage disks of the mass storage device. It will be understood that the fiber channel may be utilized for connectivity to tape drives and the like as well as disk storage.

In conventional storage infrastructures utilizing fiber channel, each project group that was adding servers and/or storage would generally install the server and/or storage equipment and do all the connections between the servers and storage at the time of installation. Such an installation would typically require weeks to plan and implement and would require multiple cable runs to be made at the time of installation. More particularly, a conventional fiber channel installation typically utilizes a serial daisy chaining of a plurality of linear jumpers to couple a host bus adaptor of a server to a fiber channel switch and an additional plurality of daisy chained linear jumpers to connect the switch to the front edge fiber adaptor of a mass storage device. Such an installation can be complex, labor intensive and subject to failures as the individual linear jumpers are typically routed under the floor panels in the area including the respective devices, which generally involves routing past a variety of already installed cabling and the like. Furthermore, the use of trunk cabling is typically only utilized between floors of buildings so individual fibers or the like extend point to point in the daisy chain from each host bus adaptor or front edge fiber adaptor to a respective interface port of the fiber channel switch. Where optical fiber is utilized for the fiber channel connections, an additional concern relates to maintaining minimum bend radius control over the optical fibers to reduce the risk of damage to the fibers that may result in decreased performance or failures. Such control of minimum bend radius may be particularly difficult when feeding daisy chained linear jumpers through spaces having already installed cabling, power lines and the like that must be routed past by the installer.

### SUMMARY OF THE INVENTION

In some embodiments of the present invention, storage network interconnection systems have a server connection section including a plurality of connector members coupled to respective optical fibers extending to a server distribution point, the server distribution point being configured to couple ones of the optical fibers to storage device interface ports of selected computers. A storage device connection section includes a plurality of connector members coupled to respective optical fibers extending to a storage device distribution point, the storage device distribution point being configured to couple ones of the optical fibers to storage device interface ports of selected storage devices. A switching section includes a plurality of connector members coupled to respective optical fibers extending to a predetermined location where a fiber channel switch having interface ports is to be located, the fiber channel switch being configured to provide selectable cross-connection of a plurality of the interface ports of the fiber channel switch to provide interconnection between the selected computers and the selected storage devices. A plurality of connector members couple ones of the selected computers and the selected storage devices to selected ones of the plurality of connector members of the switching section to couple the ones of the selected computers and the selected storage devices through the fiber channel switch in a desired configuration.

In other embodiments of the present invention, the server distribution point includes a plurality of optical fiber connectors configured to couple to optical fibers extending from the storage device interface ports of the selected computers mounted at the server distribution point, the plurality of optical fiber connectors being coupled to respective ones of the optical fibers extending to the server distribution point. The storage device distribution point includes a plurality of optical fiber connectors configured to couple to optical fibers extending from the storage device interface ports of the selected storage devices mounted at the storage device distribution point, the plurality of optical fiber connectors being coupled to respective ones of the optical fibers extending to the storage device distribution point. The optical fibers extending to the predetermined location include optical fiber connectors on an end thereof at the predetermined location, which connectors are configured to be coupled to the interface ports of the fiber channel switch.

In further embodiments of the present invention, the storage device interface ports of the selected computers are fiber channel host bus adaptors and the storage device interface ports of the selected storage devices are front end fiber adaptors. The optical fiber connectors on ends of the optical fibers extending to the predetermined location from the switching section may be coupled to interface ports of the fiber channel switch.

In other embodiments of the present invention, a first optical fiber cable extends from the server connection section to the server distribution point that includes the optical fibers coupled to the connector members of the server connection section extending therein. A second optical fiber cable extends from the storage device connection section to the storage device distribution point that includes the optical fibers coupled to the connector members of the storage device connection section extending therein. A third optical fiber cable extends from the switching section to the predetermined location that includes the optical fibers coupled to the connector members of the switching section extending therein.

In yet other embodiments of the present invention, the server connection section includes a server connection cabinet and the server distribution point includes a server area cabinet. The interconnection system further includes a server connection kit. The server connection kit includes a first patch panel mounted in the server connection cabinet and having the plurality of connector members of the server connection section mounted therein, a second patch panel mounted in the server area cabinet and having a plurality of connector members therein configured to couple the ones of the optical fibers to the storage device interface ports of the selected computers and the first optical fiber cable With the optical fibers therein coupled to the connector members in the first and second patch panels. The kit may include a plurality of first patch panels and associated second patch panels and the first optical fiber cable may be a plurality of optical fiber cables, respective ones of which extend between respective first and associated second patch panels. Ones of the selected computers may have a plurality of storage device interface ports and respective ones of the storage device interface ports may be coupled to different ones of the second patch panels so as to connect to the server connection section over optical fibers in different ones of the plurality of optical fibers. A number of the connector members on each patch panel may be a multiple of eight.

In further embodiments of the present invention, the storage device connection section includes a storage device connection cabinet and the storage device distribution point includes a storage device area cabinet. The interconnection system further includes a storage device connection kit. The storage device connection kit includes a first patch panel mounted in the storage device connection cabinet and having the plurality of connector members of the storage device connection section mounted therein, a second patch panel mounted in the storage device area cabinet and having a plurality of connector members therein configured to couple the ones of the optical fibers to the storage device interface ports of the selected storage devices and the second optical fiber cable with the optical fibers therein coupled to the connector members in the first and second patch panels. The kit may include a plurality of first patch panels and associated second patch panels and the second optical fiber cable may be a plurality of optical fiber cables, respective ones of which extend between respective first and associated second patch panels. Ones of the selected storage devices may have a plurality of storage device interface ports and respective ones of the storage device interface ports may be coupled to different ones of the second patch panels so as to connect to the storage device connection section over optical fibers in different ones of the plurality of optical fibers. A number of the connector members on each patch panel may be a multiple of eight.

In other embodiments of the present invention, the switching section includes a switching connection cabinet and the interconnection system further includes a switching connection kit. The switching connection kit includes a patch panel mounted in the switching connection cabinet and having the plurality of connector members of the switching section mounted therein, the optical fiber connectors on ends of the optical fibers extending to the predetermined location from the switching section and the third optical fiber cable with the optical fibers therein coupled to the connector members in the patch panel and to the optical fiber connectors on ends of the optical fibers extending to the predetermined location from the switching section. The kit may include a plurality of patch panels and the third optical fiber cable may be a plurality of optical fiber cables, respective ones of which extend between respective ones of the plurality of patch panels and the predetermined location. A number of the connector members on each patch panel may be a multiple of eight and a number of the patch panels and of the connector members on each patch panel may be selected to correspond to a specific model of fiber channel switch.

In other embodiments of the present invention, kits for a storage network interconnection system are provided. The kits may be server connection kits, storage device connection kits and/or switching connection kits as described above.

In yet further embodiments of the present invention, methods for interconnecting a storage network system include extending a first optical fiber cable including a plurality of optical fibers therein from a server distribution point to a server connection section of a storage network interconnection system. First ends of ones of the optical fibers are coupled to respective connector members included in the server connection section. Respective opposite second ends of the ones of the optical fibers are coupled to connector members included in the server distribution point. A second optical fiber cable including a plurality of optical fibers therein is extended from a storage device distribution point to a storage device connection section of the storage network interconnection system. First ends of ones of the optical fibers of the second optical fiber cable are coupled to respective connector members included in the storage device connection section. Respective opposite second ends of the ones of the optical fibers are coupled to connector members included in the storage device distribution point. A third optical fiber cable including a plurality of optical fibers therein is extended from a predetermined location where a fiber channel switch is to be located to a switching section of the storage network interconnection system and first ends of ones of the optical fibers of the third optical fiber cable are coupled to respective connector members included in the switching section.

In other embodiments of the present invention, storage device interface ports of selected computers are coupled to ones of the connector members included in the server distribution point. Storage device interface ports of selected storage devices are coupled to ones of the connector members included in the storage device distribution point. Second ends of ones of the optical fibers of the third optical fiber cable in the predetermined location are coupled to respective interface ports of the fiber channel switch.

In yet further embodiments of the present invention, the first, second and third optical fiber cables and connector members coupled thereto are included in respective first, second and third connection kits including patch panels having the connector members therein. Each connection kit includes a predetermined number of patch panels and connector members therein. The methods further includes identifying the selected computers, identifying the selected storage devices and identifying a specific model of fiber channel switch to be located in the predetermined area. The first, second and third connection kits are selected based on the identified selected computers, storage devices and specific model of fiber channel switch, respectively.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a schematic block diagram of a storage network interconnection system according to some embodiments of the present invention and exemplary servers, switches and storage devices.

FIGS. 2A through 2F are schematic block diagrams illustrating methods for interconnection of storage devices according to some embodiments of the present invention.

FIG. 3 is a schematic block diagram illustrating a storage interconnection kit according to some embodiments of the present invention.

FIG. 4 is a schematic block diagram illustrating a server interconnection kit according to some embodiments of the present invention.

FIGS. 5A through 5C are schematic block diagrams illustrating switch interconnection kits according to some embodiments of the present invention.

FIG. 6 is a flowchart illustrating methods for interconnecting a storage network system according to some embodiments of the present invention.

FIG. 7 is a flowchart illustrating methods for interconnecting a storage network system according to further embodiments of the present invention.

FIG. 8 is a flowchart illustrating methods for interconnecting a storage network system according to other embodiments of the present invention.

### DETAILED DESCRIPTION OF EMBODIMENTS OF THE PRESENT INVENTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated selectivity features, integers, steps, operations, elements, and/or components, but do not preclude the presence or addition of one or more other selectivity features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention is described below with reference to block diagrams and/or flowchart illustrations of methods and/or systems according to embodiments of the invention. It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

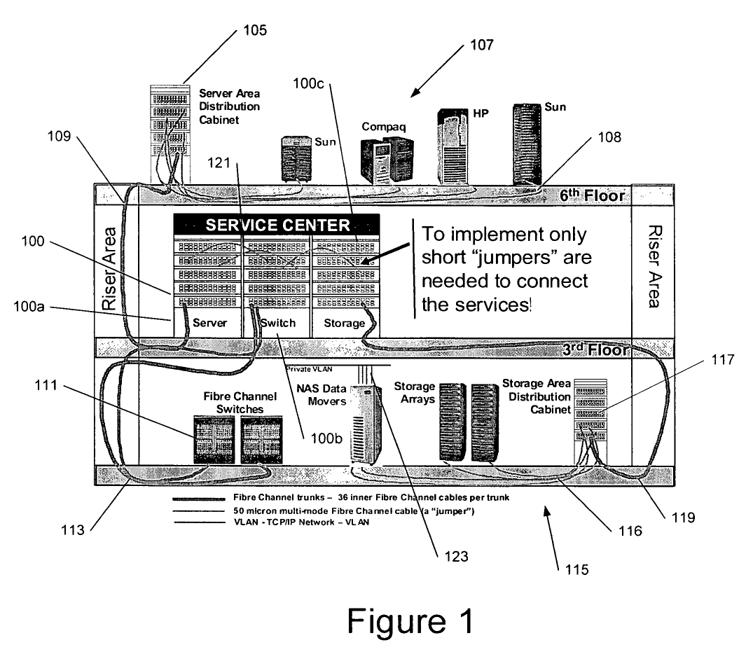

Embodiments of the present invention will now be described below with reference to FIGS. 1 through 8. Referring first to the schematic diagram of FIG. 1, a storage infrastructure is schematically illustrated as spread across multiple floors of a building. The storage infrastructure includes a storage network interconnection system 100 in a service center on one floor of the building. The storage network interconnection system 100 in the illustrated embodiments includes a server connection section 100a, a switching section 100b and a storage device connection section 100c. Each of the illustrated sections includes a plurality of connector members therein. A trunk (cable) 109 carries optical fibers coupled to ones of the connector members in the server connection section 100a to a server distribution point 105 shown as a server area distribution cabinet in FIG. 1. The server area distribution point 105 is shown on the sixth floor of the building in the proximity of a plurality of server computers 107. The server area distribution point 105 is configured to be coupled to the server computers 107 by cables 108. The cables 108 may run as individualized cables over a relatively short distance without the necessity of extending across the floors of the building.

An optical fiber cable trunk 119 also extends from the storage device connection section 100c to a storage device distribution point 117, shown as a storage device distribution cabinet in the embodiments of FIG. 1. Optical fibers in the optical fiber cable trunk 119 extend from connector members in the storage device connection section 100c to the storage device distribution point 117, where they are coupled to interface ports of selected ones of the storage devices 115. Similar to the arrangement of the servers 107 relative to the server area distribution point 105, individual interface ports of storage devices 115 may be connected through the storage area distribution point 117 by individual connector lines 116. It will be understood that, in addition to the connection provided using the fiber channel, ones of the storage devices 115 may also be coupled to a local area network 123 providing an Internet: Protocol (IP) connection for Network Attached Storage (NAS) devices.

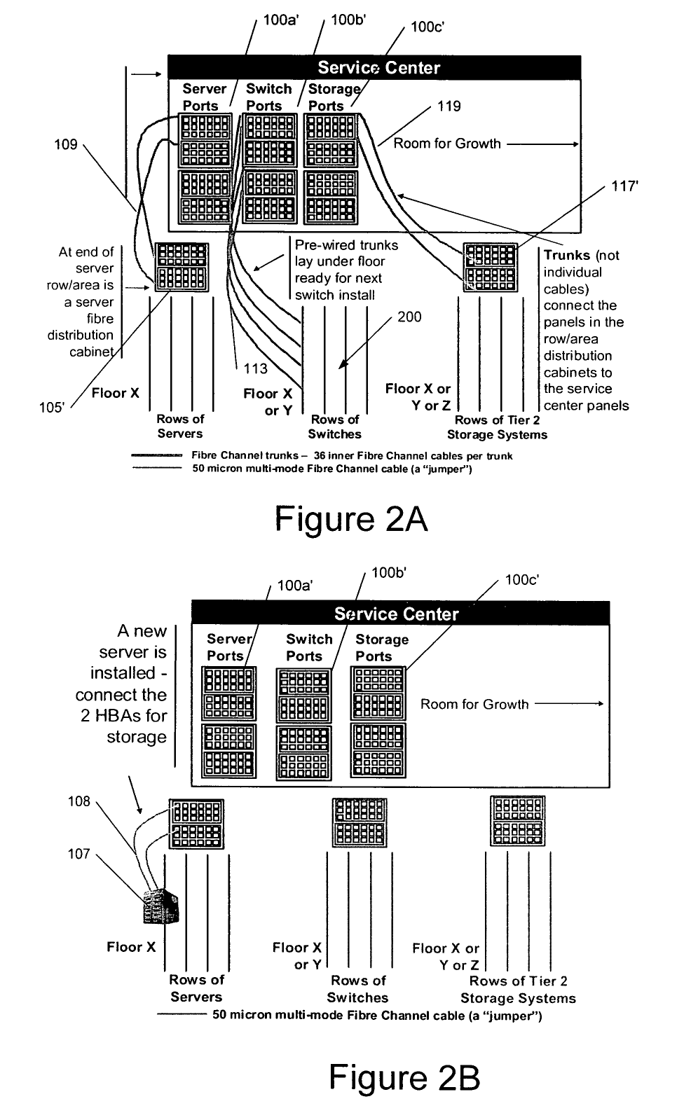

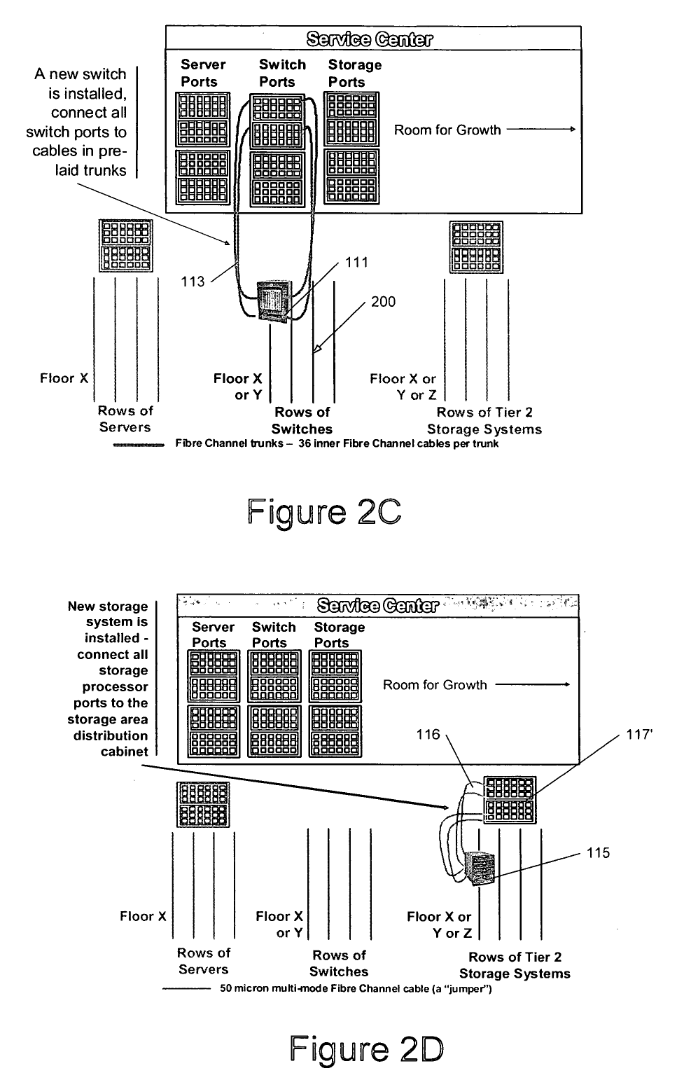

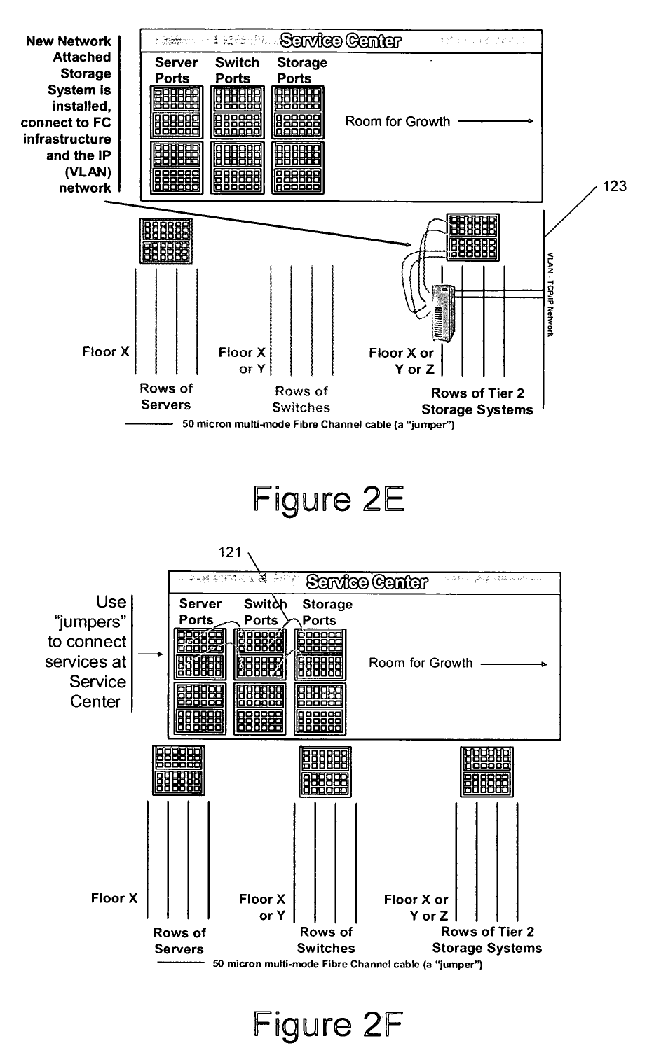

An additional optical fiber cable trunk or trunks 113 are shown extending from the switching section 110b to the fiber channel switches 111. As shown in FIG. 2A, the optical fiber cables 113 in some embodiments extend to a predetermined location 200 where the fiber channel switches 111 are to be located. For example, the cables 113 may terminate under a raised floor in the area where the fiber channel switches 111 are to be positioned. The fiber channel switches 111 are configured to provide selectable cross connection of the interface ports of the fiber channel switches 111 to provide interconnection between selected ones of the server computers 107 and selected ones of the storage devices 115. The cables 113 may include a plurality of optical fibers running therein from connector members in the switch section 100b to the vicinity of the fiber channel switches 111, where they may be coupled to interface ports of the fiber channel switches 111. Also shown in the embodiments of FIG. 1 are a plurality of connector members 121.

The jumper connector members 121 may be used to couple ones of the selected computers 107 and selected storage devices 115 to selected ones of the connector members in the switching section 100b to couple the selected computers 107 and storage devices 115 through the fiber channel switches 111 in a desired configuration.

Utilizing a storage network interconnection system 100 in accordance with various embodiments of the present invention, a number of the install time interconnection tasks as conventionally utilized in a storage infrastructure may be replaced by pre-installing of connections to planned pieces of hardware using a fiber channel trunk or the like to minimize or reduce the number of individual cable runs required to complete installation when the hardware is received. Thus, all of the connections, with the exception of the individual runs to the hardware device interface ports, may be pre-established. Such an approach in some embodiments of the present invention may reduce the number of cable errors and reduce the install time associated with a new data infrastructure product from weeks to days.

As will be further described herein with respect to various embodiments, each of the components of the pre-installed storage network interconnection system infrastructure may be predefined “kits” or component models to further expedite and minimize the effort of future expansion where the specific servers, storage devices or switches that will be utilized are identified in advance. Such an approach may be beneficial not only in the initial set up and install but in subsequent additions to an already existing infrastructure where the components and “kit” to order to expand the storage network interconnection system backbone may be specific to the storage device and/or server device to be added to the storage infrastructure. Such customized kits may not only facilitate ease of installation and reduce errors during install but may also eliminate or reduce unused components as the numbers of connectors, cables and the like utilized may be matched to the available ports on the specific switch, storage device or server to be added.

Referring now to FIGS. 2A through 2F, various embodiments of the present invention will now be further described. As shown in FIG. 2A, one or more patch panels 100a′ including a plurality of connector members, such as optical fiber connectors, may be provided in the server connection section 100a′. A plurality of optical fiber cable trunks 109 may extend from the patch panels 100a′ to patch panels 105′ in the server area distribution point 105. For example, a separate optical fiber cable could be utilized for each patch panel 100a′ at the server connection section 100a.

To provide redundancy of service access, where an individual server device 107 includes multiple host bus adaptor ports, the coupling of the server 107 may be vertically spaced across patch panels 100a′ so that different ones of the host bus interface adaptors for a given server 107 may be coupled through distinct optical fibers carried by different trunks 109, so that an access route may be maintained even if an individual optical fiber cable 109 is cut or otherwise damaged. For even further redundancy, multiple fiber optical cable trunks may extend from each patch panel as illustrated with respect to the patch panels 100b′ of the switching section 100b coupling through optical fiber cables 113 to the predetermined location 200 where switches will be located. Also shown in the embodiments of FIG. 2A are patch panels 100c′ from the storage device connection section 100c coupled through optical fiber cables 119 to patch panels 117′ including connector members positioned in the storage device distribution point 117.

The optical fibers in the optical fiber cables 113, as illustrated in the embodiments of FIG. 2A, do not terminate in connector members mounted in patch panels. In various embodiments of the present invention, the ends of the optical fibers in the predetermined location 200 include optical fiber connectors on an end thereof at the predetermined location 200, which are configured to be coupled to interface ports of the fiber channel switch 111. However, it will be understood that a patch panel approach may also be utilized in the predetermined location 200.

Referring to the schematic block diagram of FIG. 2B, operations related to adding a new server 107 will now be described. The server 107 is positioned in the server location and a cable line 108, such as an optical fiber, is utilized to couple a host bus adaptor or host bus adaptors of the server 107 to connector members in the patch panel 105 at the server area distribution point 105′.

FIG. 2C schematically illustrates installation of a new switch in the predetermined area 200. As shown in FIG. 2C, optical fiber cables 113 extend from the predetermined location 200 to couple with the backside of connector members in the switching section 100b. An installer may then connect preterminated connectors at the end of respective optical fibers to respective interface ports of the fiber channel switch 111.

FIG. 2D schematically illustrates installation of a new storage device 115. The front end fiber adaptor ports of the storage device 115 are coupled by cables/lines 116 to connector members on the patch panel 117′ of the storage device distribution point 117. As shown in FIG. 2E, where the storage device is also directly communicatively coupled to the local area network, connection to the local area network 123 may also be providing an Internet: Protocol (IP) connection for Network Attached Storage (NAS) devices. As shown in FIG. 2F, jumpers 121 are utilized at the storage network interconnection system 100 to cross connect respective storage devices and server devices through the fiber channel switch.

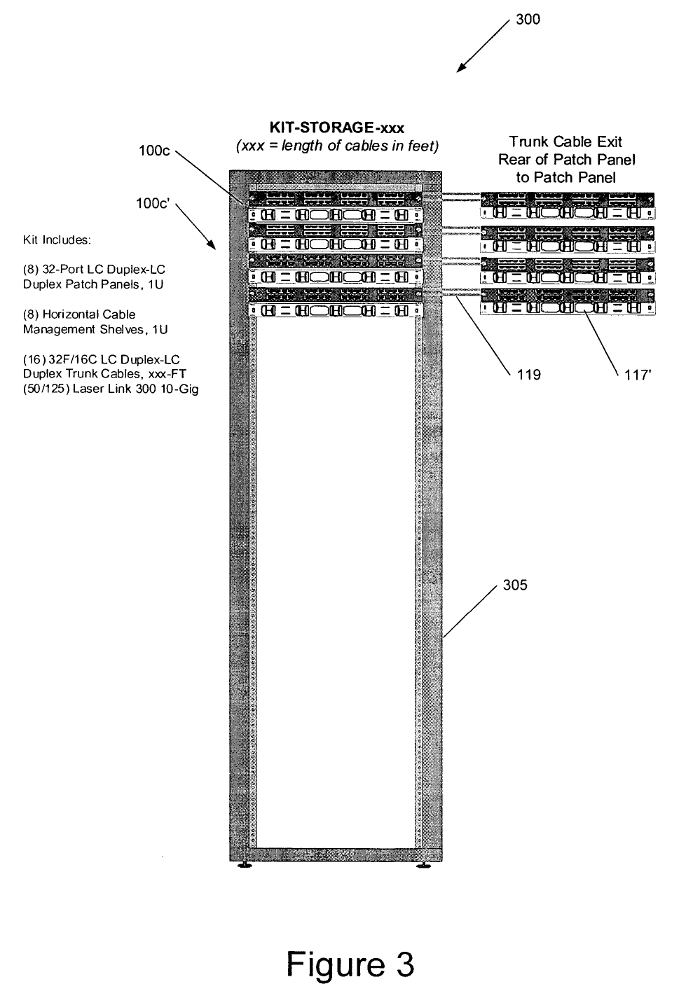

For some embodiments of the present invention, infrastructure components for the storage network interconnection system may be provided in predefined kits configured for use with respective type of devices as will now be described with reference to FIGS. 3 through 5C. FIG. 3 is a schematic diagram illustrating a storage device connection kit 300. As show in the embodiments of FIG. 3, the storage device connection section 100c includes a plurality of first patch panels 100c′ mounted in storage device connection cabinet 305. For the particular illustration of FIG. 3, four first patch panels 100c are illustrated, but other combinations from one to more than four, may be utilized for a kit based infrastructure according to some embodiments of the present invention.

For the embodiments of FIG. 3, a corresponding number of four second patch panels 117′ are illustrated that are connected to first patch panels 100c′ by optical fiber cables 119. The patch panels 117 are configured to be mounted in a storage area distribution cabinet 117. Connectors in the respective patch panels 117′ are configured to couple ones of the optical fibers in the optical fiber cable 119 to storage device interface ports of selected storage devices.

Note that, as illustrated in FIG. 3, each of the pairs of first and second patch panels are coupled by two separate optical fiber cables 119 to provide for further redundancy and flexibility in vertically spacing attachment of individual devices for increased durability and robustness relative to potential damage to the optical fiber cables 119. Further note that the appearance of the respective patch panels may be identical to simplify operations during installation by maintaining an appearance at each location consistent with the remote end, which may facilitate proper insertion and designation of ports during the installation process. Further note that the illustrated embodiments of FIG. 3 include a number of connector members on each patch panel 100c′ that is a multiple of eight, which may be more appropriate in the context of the typical configuration of interface ports on storage devices, as contrasted with the multiple of six increment conventionally used with patch panel cabinets. As also shown on FIG. 3, in addition to the eight patch panels and sixteen duplex trunk cables for the particular storage kit 300 illustrated in FIG. 3, eight horizontal cable management shelves may be provided for mounting in the respective cabinets at the service center and in the storage device area.

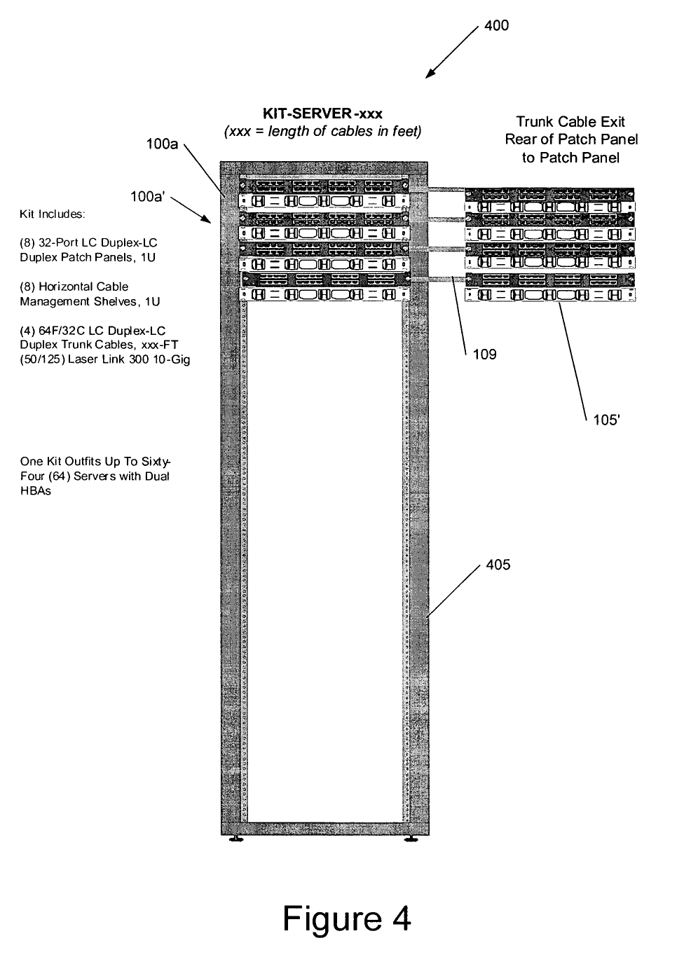

Referring now to the schematic illustration of FIG. 4, a server connection kit 400 according to some embodiments of the present invention will now be described. As show in the embodiments of FIG. 4, the server connection section 100a includes a server connection cabinet 405. The server connection kit 400 includes a plurality of first patch panels 100a′ mounted in the server connection cabinet 405 with connector members mounted therein. In addition, a plurality of second patch panels 105′ are shown that are mounted in the server area distribution cabinet 105 and have a plurality of connector members therein configured to couple fibers extending from the server connection section 100a to server interface ports of selected server computers 107. A plurality of optical fiber cables 109 are shown extending between the first patch panels and corresponding ones of the second patch panels. Optical fibers extending within the optical fiber cables 109 are coupled to corresponding connector members in the respective first and second patch panels.

As shown in the embodiments of FIG. 4, a separate optical fiber cable 109 runs from each of the first patch panels 100a′ to a corresponding second patch panel 105′. However, it will be understood that multiple cables may extend from a single patch panel or an individual cable may couple multiple patch panels. As described with reference to FIG. 3 and the storage device connection kit 300, the server connection kit 400 in the illustrated configuration may provide for greater redundancy in connection of a server having multiple host bus interfaces through vertical distribution of connector cables/lines of the insertions so that respective ones of the host bus adaptors of a given server extend into ports providing diversity in the optical fiber cable 109 used for transmission of a single signal back to the service center in case an individual optical fiber cable 109 is cut or otherwise damaged. As is also shown in the embodiments of FIG. 4, each of the patch panels may include a number of connector members that is a multiple of eight.

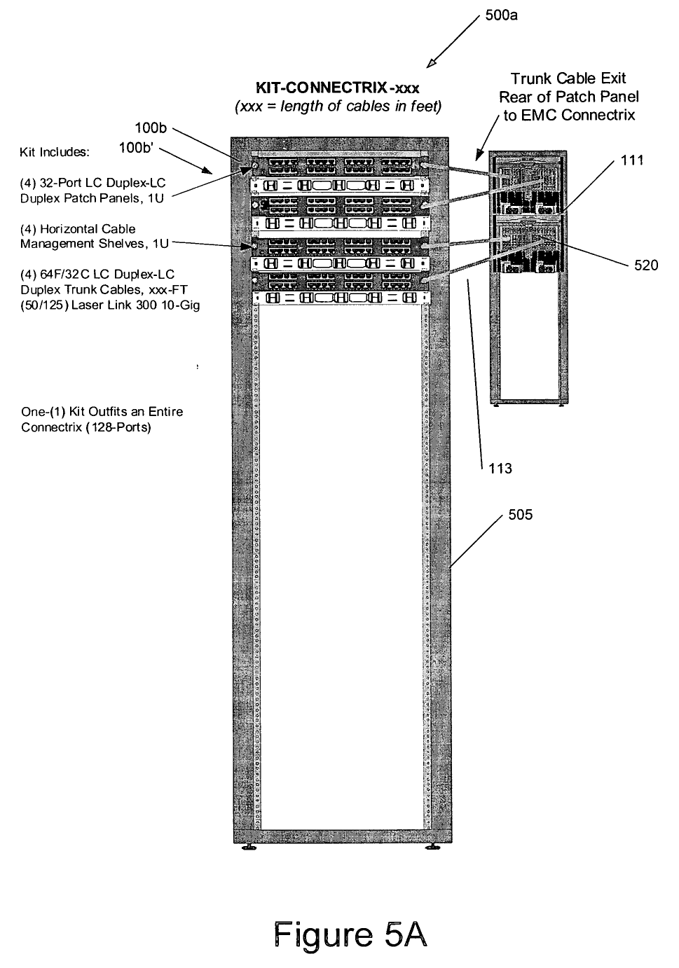

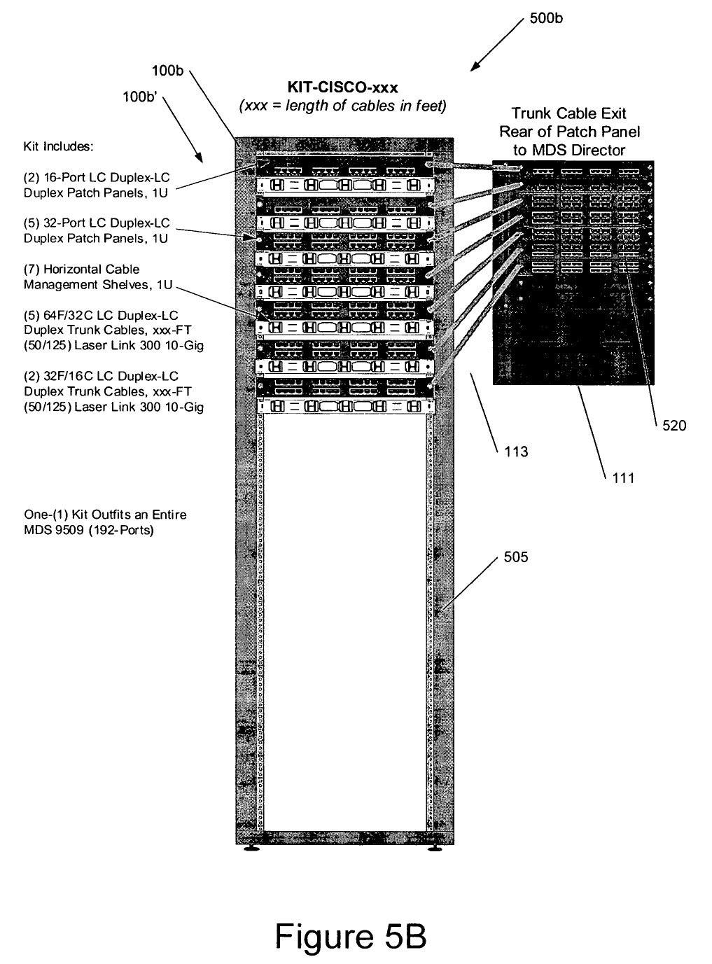

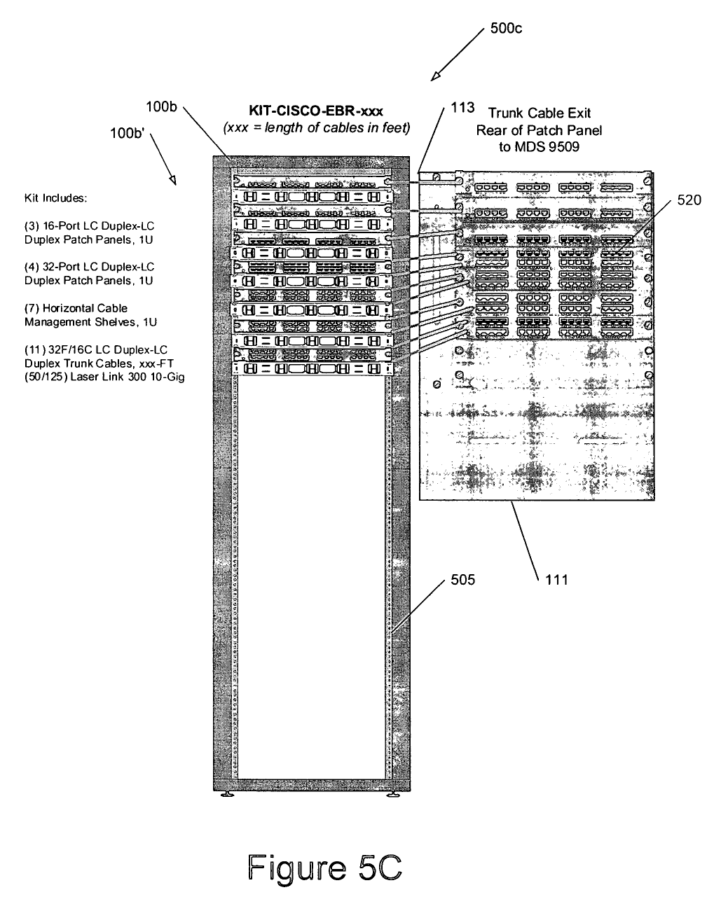

Referring now to the schematic diagrams of FIGS. 5A through 5C, various switching connection kits 500a, 500b, 500c according to some embodiments of the present invention will now be described. As shown in the embodiments of FIG. 5A, a kit 500a configured for use with an EMC Connectrix fiber channel switch available from EMC Corporation, is illustrated. FIG. 5B schematically illustrates a switching connection kit 500b configured for use with a Cisco MDS Director fiber channel switch available from Cisco Systems, Inc. FIG. 5C illustrates a switching connection kit 500c configured for use with an MDS Director fiber channel switch from Cisco having a different configuration from that shown in FIG. 5B so as to correspond to a different configuration of the MDS Director, in particular, an MDS 9509 fiber channel switch.

As shown in FIGS. 5A through 5C, each of the switching connection kits 500a, 500b, 500c includes a plurality of patch panels 100b′ mounted in a switching connection cabinet 505 of the switching section 100b with a plurality of connector members mounted thereon. Optical fiber cables 113 extend from the connector members of the patch panels 100b′ with optical fibers therein coupled to the connector members in the patch panels 100b′ and terminating in the optical fiber connectors on ends of the optical fibers of the optical fiber cables 113 at the predetermined location 200. The optical fiber connectors in the predetermined location 200 are configured to couple to interface ports 520 of the respective fiber channel switches 111.

For the embodiments of FIGS. 5A and 5B, a single optical fiber cable 113 is shown extending from each of the patch panels 100b′. For the embodiments illustrated in FIG. 5C, single fiber cable 113 extend from each sixteen port patch panel while two optical fiber cables 113 extend from each thirty two port patch panel. In some embodiments, the kits further include cable management shelves that may be mounted in the switching section cabinet 505 to aid in management of cable routing.

By providing kits specifically configured for use with a specific model of fiber channel switch, wasted connectors and the like may be avoided and installation may be simplified by providing an interface configuration at the remote service center location that corresponds to the specific interface structure of the respective fiber channel switch to simplify keeping track of the specific port number at a fiber channel switch that is being utilized when jumper connectors are put in place at the service center. Thus, while the specific configuration of components is illustrated with respect to particular known models of fiber channel switches, it will be understood that other configurations utilized where configuring such kits may beneficially be based upon the characteristics of a particular fiber channel switch. Further note that the respective patch panels 100b′ may include a number of connector members on each patch panel that is a multiple of eight.

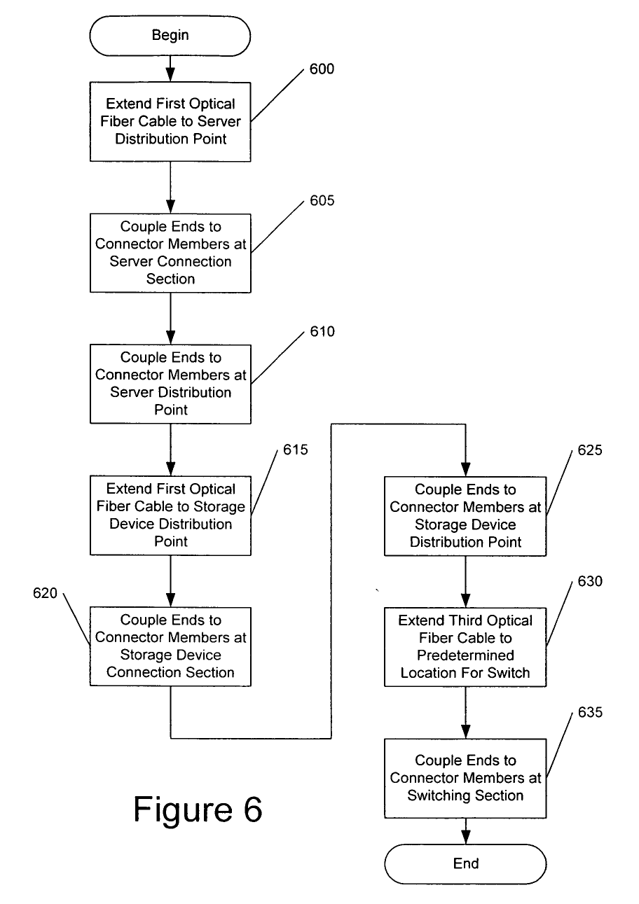

Methods for interconnecting a storage network system according to various embodiments of the present invention will now be described with reference to the low chart illustrations of FIGS. 6 through 8. Referring first to the embodiments of FIG. 6, operations begin with extending a first optical fiber cable including a plurality of optical fibers therein from a server distribution point to a server connection section of a storage network interconnection system (Block 600). First ends of ones of the optical fibers are coupled to respective connector members included in the server connection section (Block 605). Respective opposite second ends of the optical fibers are coupled to connector members included in the server connection distribution point (Block 610).

A second optical fiber cable including a plurality of optical fiber cables therein is extended from a storage device distribution point to a storage device connection section of the storage network interconnection system (Block 615). First ends of ones of the optical fibers of the second optical fiber cable are coupled to respective connector members included in the storage device connection section (Block 620). Respective opposite second ends of the optical fibers are coupled to connector members included in the storage device distribution point (Block 625).

A third optical fiber cable including a plurality of optical fibers therein is extended from a predetermined location where a fiber channel switch is to be located to a switching section of a network interconnection system (Block 630). First ends of ones of the optical fibers in the third optical fiber cable are coupled to respective connector members included in the switching section (Block 635). The opposite ends of the optical fibers of the third optical cable may be pre-connectorized at the predetermined location as described above.

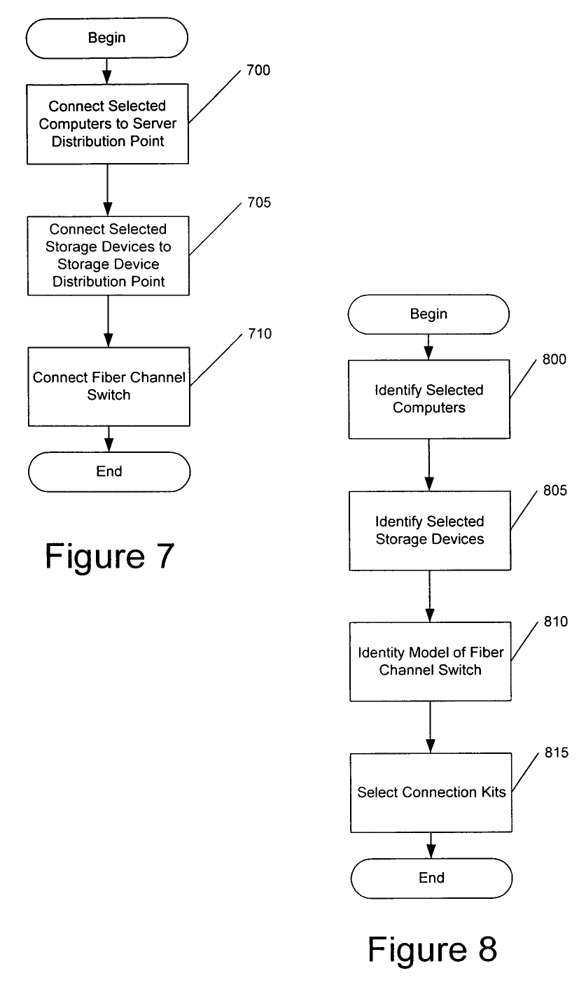

Further embodiments of methods for interconnecting a storage network system will now be described with reference to FIG. 7. For the embodiments illustrated in FIG. 7, it will be understood that the basic infrastructure has been installed as described with reference to FIG. 6 in some embodiments of the present invention. For the embodiments of FIG. 7, further operations include connecting storage device interface ports of selected computers (servers) to ones of the connector members included in the server distribution point (Block 700). Storage device interface ports of selected storage devices are connected to ones of the connector members included in the storage device distribution point (Block 705). Second ends of the optical fibers of the third optical fiber cable in the predetermined location where the fiber channel switch is to be located are connected to respective interface ports of the fiber channel switch (Block 710).

Additional operations for some embodiments of the present invention utilizing kits in establishing the storage network interconnection system will now be described with reference to FIG. 8. As noted above, the kits may include the respective first, second and third optical fiber cables and connector members coupled thereto in kits including patch panels with the connectors mounted therein. Each connection kit may include a predetermined number of patch panels and connector members therein as discussed previously. As illustrated in FIG. 8, operations being by identifying the selected computers to be serviced by the server area distribution cabinet (Block 800). The selected storage devices to be included in the infrastructure are also identified (Block 805). In addition, a specific model of fiber channel switch (or switches) to be located in the predetermined area is identified (Block 810). The first, second and third connection kits are selected based on the identified selected computers, storage devices and specific model of fiber channel switch, respectively (Block 815).

As described above with respect to various embodiments of the present invention, storage components and servers of a storage infrastructure may be connected together utilizing a pre-provisioned fiber channel storage area network (SAN) service area designed in accordance with some embodiments of the present invention. The fiber channel SAN service center in some embodiments includes zone cabinets, fiber trunks, patch panels, service centers and jumper cables. These various components may make up predefined kits or component models so that future expansion may be accomplished with minimal effort. The location of the expansion need may determine the components and kits to order. Such an approach in accordance with some embodiments of the present invention may ensure consistent components are ordered time after time and that the overall infrastructure interconnection system standard design is adhered to. Accordingly, installation and maintenance of a storage infrastructure may be more efficiently and reliably provided.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A storage network interconnection system, comprising:
a server connection section including a plurality of connector members coupled to respective optical fibers extending to a server distribution point, the server distribution point being configured to couple ones of the optical fibers to storage device interface ports of selected computers;
a storage device connection section including a plurality of connector members coupled to respective optical fibers extending to a storage device distribution point, the storage device distribution point being configured to couple ones of the optical fibers to storage device interface ports of selected storage devices;
a switching section including a plurality of connector members coupled to respective optical fibers extending to a predetermined location where a fiber channel switch having interface ports is to be located, the fiber channel switch being configured to provide selectable cross-connection of a plurality of the interface ports of the fiber channel switch to provide interconnection between the selected computers and the selected storage devices; and
a plurality of connector members for coupling ones of the selected computers and the selected storage devices to selected ones of the plurality of connector members of the switching section to couple the ones of the selected computers and the selected storage devices through the fiber channel switch in a desired configuration.

2. The storage network interconnection system of claim 1, wherein the server distribution point comprises a plurality of optical fiber connectors configured to couple to optical fibers extending from the storage device interface ports of the selected computers mounted at the server distribution point, the plurality of optical fiber connectors being coupled to respective ones of the optical fibers extending to the server distribution point and wherein the storage device distribution point comprises a plurality of optical fiber connectors configured to couple to optical fibers extending from the storage device interface ports of the selected storage devices mounted at the storage device distribution point, the plurality of optical fiber connectors being coupled to respective ones of the optical fibers extending to the storage device distribution point and wherein the optical fibers extending to the predetermined location include optical fiber connectors on an end thereof at the predetermined location, which connectors are configured to be coupled to the interface ports of the fiber channel switch.

3. The storage network interconnection system of claim 2 wherein the storage device interface ports of the selected computers comprise fiber channel host bus adaptors and wherein the storage device interface ports of the selected storage devices comprise front end fiber adaptors.

4. The storage network interconnection system of claim 3 further comprising the fiber channel switch and wherein the optical fiber connectors on ends of the optical fibers extending to the predetermined location from the switching section are coupled to interface ports of the fiber channel switch.

5. The storage network interconnection system of claim 3, further comprising:
a first optical fiber cable extending from the server connection section to the server distribution point and including the optical fibers coupled to the connector members of the server connection section extending therein;
a second optical fiber cable extending from the storage device connection section to the storage device distribution point and including the optical fibers coupled to the connector members of the storage device connection section extending therein; and
a third optical fiber cable extending from the switching section to the predetermined location and including the optical fibers coupled to the connector members of the switching section extending therein.

6. The storage network interconnection system of claim 5, wherein the server connection section includes a server connection cabinet and the server distribution point includes a server area cabinet, the interconnection system further comprising a server connection kit, the server connection kit including:
a first patch panel mounted in the server connection cabinet and having the plurality of connector members of the server connection section mounted therein;
a second patch panel mounted in the server area cabinet and having a plurality of connector members therein configured to couple the ones of the optical fibers to the storage device interface ports of the selected computers; and
the first optical fiber cable with the optical fibers therein coupled to the connector members in the first and second patch panels.

7. The storage network interconnection system of claim 6 wherein the kit includes a plurality of first patch panels and associated second patch panels and wherein the first optical fiber cable comprises a plurality of optical fiber cables, respective ones of which extend between respective first and associated second patch panels.

8. The storage network interconnection system of claim 7 further comprising the selected computers and wherein ones of the selected computers have a plurality of storage device interface ports and respective ones of the storage device interface ports are coupled to different ones of the second patch panels so as to connect to the server connection section over optical fibers in different ones of the plurality of optical fibers.

9. The storage network interconnection system of claim 7 wherein a number of the connector members on each patch panel is a multiple of eight.

10. The storage network interconnection system of claim 5, wherein the storage device connection section includes a storage device connection cabinet and the storage device distribution point includes a storage device area cabinet, the interconnection system further comprising a storage device connection kit, the storage device connection kit including:
a first patch panel mounted in the storage device connection cabinet and having the plurality of connector members of the storage device connection section mounted therein;
a second patch panel mounted in the storage device area cabinet and having a plurality of connector members therein configured to couple the ones of the optical fibers to the storage device interface ports of the selected storage devices; and
the second optical fiber cable with the optical fibers therein coupled to the connector members in the first and second patch panels.

11. The storage network interconnection system of claim 10 wherein the kit includes a plurality of first patch panels and associated second patch panels and wherein the second optical fiber cable comprises a plurality of optical fiber cables, respective ones of which extend between respective first and associated second patch panels.

12. The storage network interconnection system of claim 11 further comprising the selected storage devices and wherein ones of the selected storage devices have a plurality of storage device interface ports and respective ones of the storage device interface ports are coupled to different ones of the second patch panels so as to connect to the storage device connection section over optical fibers in different ones of the plurality of optical fibers.

13. The storage network interconnection system of claim 11 wherein a number of the connector members on each patch panel is a multiple of eight.

14. The storage network interconnection system of claim 5, wherein the switching section includes a switching connection cabinet, the interconnection system further comprising a switching connection kit including:
a patch panel mounted in the switching connection cabinet and having the plurality of connector members of the switching section mounted therein;
the optical fiber connectors on ends of the optical fibers extending to the predetermined location from the switching section; and
the third optical fiber cable with the optical fibers therein coupled to the connector members in the patch panel and to the optical fiber connectors on ends of the optical fibers extending to the predetermined location from the switching section.

15. The storage network interconnection system of claim 14 wherein the kit includes a plurality of patch panels and wherein the third optical fiber cable comprises a plurality of optical fiber cables, respective ones of which extend between respective ones of the plurality of patch panels and the predetermined location.

16. The storage network interconnection system of claim 15 wherein a number of the connector members on each patch panel is a multiple of eight and wherein a number of the patch panels and of the connector members on each patch panel is selected to correspond to a specific model of fiber channel switch.

17. A kit comprising the server connection kit of claim 6, the storage device connection kit of claim 10 and/or the switching connection kit of claim 14.

18. A method for interconnecting a storage network system, comprising:
extending a first optical fiber cable including a plurality of optical fibers therein from a server distribution point to a server connection section of a storage network interconnection system;
coupling first ends of ones of the optical fibers to respective connector members included in the server connection section;
coupling respective opposite second ends of the ones of the optical fibers to connector members included in the server distribution point;
extending a second optical fiber cable including a plurality of optical fibers therein from a storage device distribution point to a storage device connection section of the storage network interconnection system;
coupling first ends of ones of the optical fibers of the second optical fiber cable to respective connector members included in the storage device connection section;
coupling respective opposite second ends of the ones of the optical fibers to connector members included in the storage device distribution point;
extending a third optical fiber cable including a plurality of optical fibers therein from a predetermined location where a fiber channel switch is to be located to a switching section of the storage network interconnection system; and
coupling first ends of ones of the optical fibers of the third optical fiber cable to respective connector members included in the switching section.

19. The method of claim 18, further comprising:
connecting storage device interface ports of selected computers to ones of the connector members included in the server distribution point;
connecting storage device interface ports of selected storage devices to ones of the connector members included in the storage device distribution point; and
connecting second ends of ones of the optical fibers of the third optical fiber cable in the predetermined location to respective interface ports of the fiber channel switch.

20. The method of claim 18, wherein the first, second and third optical fiber cables and connector members coupled thereto are included in respective first, second and third connection kits including patch panels having the connector members therein, each connection kit including a predetermined number of patch panels and connector members therein, and wherein the method further comprises:
identifying the selected computers;
identifying the selected storage devices;
identifying a specific model of fiber channel switch to be located in the predetermined area; and
selecting the first, second and third connection kits based on the identified selected computers, storage devices and specific model of fiber channel switch, respectively.
